(19) United States
(12) Patent Application Publication
(10) Pub. No.: US 2025/0187039 A1
(43) Pub. Date: Jun. 12, 2025

(54) A SORTING SYSTEM

(71) Applicant: HYSORT LIMITED, Warwickshire (GB)

(72) Inventor: David Hyslop, Warwickshire (GB)

(21) Appl. No.: 18/845,399

(22) PCT Filed: Mar. 10, 2023
(86) PCT No.: PCT/GB2023/050570

§ 371 Date: Sep. 9, 2024

(30) Foreign Application Priority Data
Mar. 11, 2022 (GB) 2203387.2

(51) Int. Cl. B07C 5/36; B65G 1/04

(52) U.S. Cl. CPC B07C 5/362; B65G 1/0492

(57) ABSTRACT

A system for sorting items which includes at least one independently-driven sorter carrier within a framework, wherein the sorting system spans at least two floors of a warehouse, and the sorter carriers are configured to move within the framework and collect at least one item, and to move to at least one sort destination on any of the floors of the warehouse, such that items are sorted into at least one order.

This specification relates to item sorting. In particular, although not exclusively, this specification relates to an item sorting system.

Modern warehouses, particularly those doing e-commerce fulfilment can frequently contain a great many different products or stock keeping units (SKU's). These stock keeping units are frequently spread over many floors within the warehouse for example on multi-tier mezzanine structures. This has the advantage of high utilisation of the cubic space within the building and minimising the land and building footprint used. When an individual order is received which requires items from more than one floor there is a need to bring together or consolidate these items before putting them into the order carton or shipping container.

Currently this is achieved in several ways. Firstly, product containers e.g., pallets, racks, totes, or shelves, can be moved from other floors until all the product storage containers required reach a picking position on one of the floors or levels. Individual items are then picked from the product containers and put either directly into the required container or inducted onto a sorting machine which sorts into the required order carton or shipping container.

This type of solution may present the disadvantage that the product container most likely contains items which are not required for the current or other orders that day but the total weight of container and items is moved. Moving these additional unneeded items requires automation or manual transportation capable of handling the whole container and all items to the picking position and moving it back again once the few required items have been picked. The container is, most likely, returned to the same floor where it originated. The energy used and equipment required to move the excess items is wasted.

An alternative method may entail picking an item from the first floor of the warehouse into the order container or shipping carton and then transporting the order container over conveyers or other automation to the subsequent floors where the remaining items are picked into the order container. This solution may present the disadvantage that the order container needs to be transported across multiple floors resulting in wasted transportation movements and potentially a longer time to fully process the order prior to shipping to the customer. Increasingly customers wish to order later and later into the day and still get next day delivery or in some cases same day delivery.

Another alternative method is to pick the items required, on all of the floors of the warehouse, then transport those items either as single items on a conveyor or as a batch of items in a carrier (e.g. a tote) to one of the warehouse floors where the items can be subsequently sorted, by an operator or machine, into the relevant orders. In this scenario each item to be packed has to be touched twice-one touch at the point of picking and one touch at the point of sorting into the specific order.

Alternatively, the individual items can be stored on the floors of a warehouse in a container, frequently a hanger or pouch, and the items transported still within the container to a single floor where they are sorted, the items removed from the container and the empty container returned to storage (either after refilling or empty). This method has the disadvantage of having to move and return a container for each individual item picked, along with having to load multiple containers, hangers or pouches, prior to the items being put into storage, awaiting picking, even if they are subsequently ordered in multiple unit quantities.

Often, when items are to be packed from multiple floors, it may be such that items are picked from the top floor, put in a tote, placed on a conveyor to the ground floor, with further items picked from the middle floor, put in a tote, placed on conveyor to the ground floor, items picked on the ground floor, and these items moved to packing area (at which the items from the top and middle floors would also be received). The collating of the items would all occur on the ground floor.

Therefore, a mechanism for improving the efficiency of collating orders from items stored on multiple floors, or areas, of a warehouse has been developed. This may employ a number of sorting machines containing independently driven carriers, a rail framework over which the carriers move, item induction positions and a number of lifts or elevators which are configured to move the independent carriers between layers or tiers of the framework and past sort destinations. These machines typically contain both item induct points and sort destinations and can operate as stand alone sorting machines.

These sorting machines can be linked together with additional lift elements or horizontal transfers which allow the independently driven carriers to move between warehouse floors or across different sortation machines. In this configuration a sorting machine can be thought of as a portion of the overall sorting system in the warehouse. In which case a portion of the system may contain only some of the elements or functions of a complete standalone sorting machine. From time to time, these portions or sorting machines may operate independently, for example when another part of the overall sorting system is turned off or undergoing maintenance. The sorting machines, (or portions), are interconnected into the overall sorting system by further lifts or elevators, or lift extensions, which may move the independent carriers between further sorting machines or portions of the sorting system.

In summary, such sorting systems, machines or portions of sorting systems may be placed upon another floor of a warehouse or storage facility. Additionally, a horizontal section can be used to move carriers across warehouse sections or areas interlinking sorting machines (or sorting system portions).

A first aspect of the invention provides a sorting system which includes at least one independently-driven sorter carrier within a framework, wherein the sorting system spans at least two floors of a warehouse, and the sorter carriers are configured to move within the framework and collect at least one item, and to move to at least one sort destination on any of the floors of the warehouse, such that items are sorted into at least one order.

Preferably, the or each sorter carrier is further configured to offload the at least one item at the at least one sort destination.

Conveniently, the framework spans the at least three floors of the warehouse.

Advantageously, the sorting system further includes a lift arrangement.

Preferably, the lift arrangement is configured to pass through or between the floor of the warehouse and between a first portion of the framework and a second portion of the framework.

Conveniently, the lift arrangement is installed at a first end of a floor of the warehouse.

Advantageously, the lift arrangement is formed of two or more lifts.

Preferably, the first lift is positioned at a first end of the framework, and the second lift is positioned at a second end of the framework.

Conveniently, the first lift is positioned at a first end of the framework, and the second lift is positioned at a location along the length of the framework.

Alternatively, the first and second lifts are each formed of two or more lifts.

Advantageously, the sorting arrangement spans at least three floors of the warehouse, and the framework is present on the at least three floors of the warehouse, further including lifts which pass between the first and second, and second and third floors respectively.

Preferably, the sorting system further includes an additional portion of framework on the same floor of the warehouse.

Conveniently, the additional portion of framework is connected to the existing framework by way of a horizontal transfer arrangement.

Advantageously, the horizontal transfer arrangement is an elevated above ground level.

Preferably, the horizontal transfer arrangement is elevated above ground level such that a person may walk under the transfer and allow access to other areas of the warehouse.

Alternatively, the horizontal transfer arrangement is a belt, or chain driven arrangement.

Conveniently, the horizontal transfer arrangement is part way along a top row of sort destinations.

Advantageously, the horizontal transfer arrangement is accessed by the lift arrangement.

Preferably, the sorting system includes at least two sorter carriers.

Conveniently, the lift arrangement is configured such that when a first sorter carrier is moved in a first lift, a second sorter carrier is moved in a second lift.

Advantageously, the sorting system further includes a capacity management arrangement.

Preferably, the capacity management arrangement is configured to optimise, reduce, or balance the movements of sorter carriers within the sorting system which spans multiple floors and areas of a warehouse to maintain a desired balance of the number of carriers on each floor and in each area facilitating high capacity of the system.

Conveniently, the capacity management arrangement is configured further to optimally sequence orders to be processed and to allocate these orders or (groups of items to be collated) to available sort destinations within a framework of destinations in order to optimize, balance or reduce the sorter carrier movements between floors or areas. The control system may take into account the existing orders allocated to sort destinations, future orders to be allocated and the existing and expected positions of sorter carriers.

Advantageously, the capacity management is configured further to optimize, reduce, and/or balance the movement of sorter carriers between floors or areas of the sorter system by controlling the floor or area where an item is inducted into the system when the item is available in multiple stock locations within the warehouse.

Alternatively, the capacity management arrangement is configured to balance the movement of the or each sorter carrier within the system by moving another carrier into the sorting machine or system portion the first carrier left, wherein the real-time demand is determined by one or more of the number of items in the sorting system, the floor on which items to be inducted in the system are positioned, or the floor, or position, of the relevant sort location, and/or wherein the movement of the or each sorter carrier in the system is controlled such that the position of the or each sorter carrier is determined based upon the real-time demand on the sorting system.

### BRIEF DESCRIPTION OF THE DRAWINGS

An exemplary embodiment of the present invention is illustrated by way of example in the accompanying drawings in which like reference numbers indicate the same or similar elements and in which:-

FIG. 1a shows an exemplary sorter carrier which may be deployed within the present invention;

FIG. 1b shows an alternative, exemplary sorter carrier which may be deployed within the present invention;

FIG. 2 shows an exemplary sorting machine using a number of carriers which may be deployed within the present invention;

FIG. 3 shows an exemplary sorting machines in a warehouse or storage facility setting on different floors and linked by a lift;

FIG. 4 shows three sorting machines within a warehouse or storage facility setting;

FIG. 5 shows three sorting machines with a lift arrangement;

FIG. 6 shows three sorting machines with an alternative lift arrangement;

FIG. 7 shows three sorting machines with a further alternative lift arrangement;

FIG. 8 shows three sorting machines with a yet further alternative lift arrangement;

FIG. 9 shows three sorting machines with a yet further different alternative lift arrangement;

FIG. 10 shows three sorting machines in an offset configuration; and

FIG. 11 shows three sorting machines and a horizontal transfer arrangement.

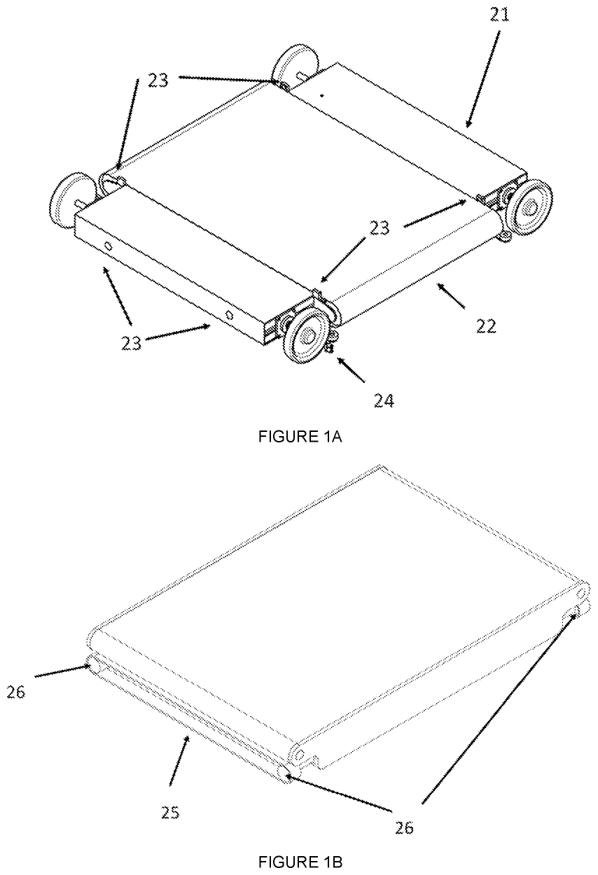

Turning now to FIG. 1a, there is shown a sorter carrier 21 with a discharge mechanism 22. In the example shown in FIG. 1a, the discharge mechanism is a conveyor belt driven across the carrier perpendicular to the direction of travel of the carrier.

The sorter carrier 21 shown in FIG. 1a includes a number of features, each of which will be discussed in turn below.

The sorter carrier 21 may include an apparatus configured to drive the sorter carrier 21 in both the forward and reverse direction. Such an apparatus may be a motor or motors. Additionally, the sorter carrier 21 may include an apparatus configured to drive the discharge belt or discharge mechanism to eject the item into the sort destination. As with the drive apparatus, this may be a motor or motors, or an actuator.

Further, the sorter carrier 21 may include an apparatus configured to control the movement and position, along with item loading and discharge, collision avoidance and communication with the other system controllers or the other sorter carriers 21.

This control apparatus may be a microprocessor controller or PLC, or suitable alternative.

The sorter carrier 21 may also include sensors 23 to detect the position of the sorter carrier 21 within a rail structure, along with other parameters such as overhang of product and for collision avoidance. In addition to that discussed above, the sorter carrier 21 may include an optional energy store, which may include or comprise a battery or capacitor, and a power pick-up mechanism 24 to power the carrier or to recharge the energy store.

In the case of the sorter carrier 21 shown in FIG. 1a, the wheels are fixed, that is to say that they are not capable of ‘steering’. Such a sorter carrier 21 may, for example, include one or more steering axes to enable the wheels of the sorter carrier 21 to steer and thus the sorter carrier 21 be able to move along curved rails.

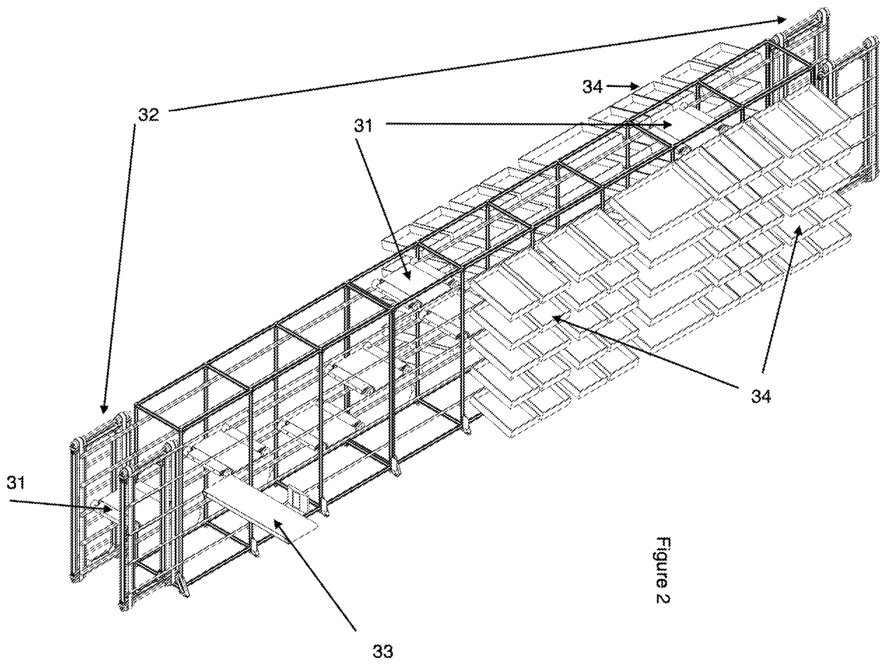

In addition, the sorter carrier 21 may be low profile, that is to say the overall height of the sorter carrier may be minimised, to allow for an item with a large height to be transported on the sorter carrier 21. As can be seen from the rail arrangement of the sorting machine in FIG. 2 (discussed below), a first sorter carrier 21 may need to pass under a moving further sorter carrier 21, and if an item with a large height is to be moved within the sorting machine, there is a possibility that the top of the item may foul or catch on the sorter carrier 21 moving thereabove.

It may therefore be advantageous for the overall height of the sorter carrier 21 to be relatively low in order to avoid collisions with items on other sorter carriers 21 in a sorting machine.

Turning now to FIG. 1b, there is shown an alternative carrier with tank tracks instead of wheels. On this version a timing belt 25 (the tank track) is driven between the wheels 26 (drive pulleys) giving a large contact area with the rail. If needed multiple wheels/pulleys can be placed along the length of the track to press the belt down against the rail.

It is envisaged that a similar carrier which may be able to steer may be used in a sorting machine which may employ a continuous track or rail, that is to say that the track forms a loop or circuit. Such a track may also be sloping, curved, or multi-level. In a situation where the track is multi-level, a curved, inclined, or curved and inclined track may be used to allow the sorter carrier to move between levels of the machine. Such a track may be used as an alternative to the lift shown in FIG. 2 and discussed below.

It is also envisaged that a sorter carrier 21 similar to that shown in FIG. 1a may be used in a sorting machine having a continuous track, with the sorter carrier 21 having steering axles on the wheels thereof to allow the sorter carrier 21 to move around curved sections of the machine.

FIG. 2 shows multiple carriers 31 in a sorting machine consisting of lifts 32 to move carriers between levels, item induct position 33, and five levels of sort destinations 34 in this example the destinations are totes but they could be chutes, boxes, bags etc.

The sorting machine of FIG. 2 may be one of a plurality of sorting machines in a warehouse or other storage facility.

The sorting machine shown in FIG. 2 includes a lift at each end of the sorting machine, one at each end thereof. The lifts at each end of the sorting machine are configured to move sorter carriers 31 between the levels of the sorting machine.

The interaction between the lifts, the levels of sort destinations, and the sorter carriers will now be discussed.

The cycle may begin with a carrier 31 at the induct position. An item is placed onto the induction belt 33. A barcode on the item may be scanned, either by the operator using a hand-held scanner or by an automatic scanner whilst the item is moving over the induction belt 33. The controller may use the data from the barcode to look up a database to determine the items intended destination. The database may also give the item attribute data such as weight, dimensions and coefficient of friction. The sorter controller passes the items destination to the carrier controller along with any other data by infrared or radio frequency communication. Bluetooth, WiFi or other RF protocols can be used.

A sorter carrier may move onto any of the lifts in the sorting machines described herein. The lift controller has been informed by the main sorter controller (or the lift shares the main sorter controller) what level to take the carrier and item to. Before the lift moves to the destination level. An optional vision system may be connected to the main sorter controller and may capture a picture of the item on the carrier. Once the image is captured the lift may begin to move to the destination level. The vision system may be used to work out the effective dimensions of the item and the position on the belt.

Once the lift has completed its move to the destination level the induct level is now available to receive another carrier. The main controller calculates the optimum discharge parameters of the item from the carrier and communicates these to the carrier controller. In a variant, the sorter communicates basic information and the carrier determines the optimum discharge speed and the like. Once the first carrier has moved of the lift towards its destination the vision system, if present, can capture the image of the item on a second carrier if it has arrived.

The first carrier proceeds towards the sort destination. This may be on the current level of the carrier or on the induct level. If it is the induct level then the carrier will proceed directly to the opposite end of the machine and move over the return lift before proceeding to the sort destination. If the destination is on the current level the carrier may drive at top speed towards the destination. When at an appropriate distance from the destination the carrier begins to decelerate to the discharge speed between top speed and zero m/s. The time at which this deceleration starts is the beginning of the discharge time (‘DT’). At a point along the path the carrier fires the discharge belt, or mechanism, to offload the item into the destination.

The discharge belt may be a conveyor belt driven at 90 degrees to the direction of travel of the carrier and this drives the item from the carrier into the destination tote, chute, bag or other type of destination.

The point the carrier starts deceleration, the deceleration rate, the point at which the discharge belt starts and stops may be determined by the controller taking into account the item attribute data and effective dimensions and position of the item on the carrier if available. The item attribute data and the effective dimensions may be obtained by sensors as an alternative to the optional vision system or not used whereby the sorter carrier may stop at the destination prior to discharging the item.

Once the item has been fully discharged the carrier re-accelerates to the desired speed to continue its journey to the next lift, induct point or other point in the system. The time to discharge (‘DT’) is complete once the carrier has reached its desired speed for the onward journey. It is to be understood that if the carrier is close to the return lift or induct point the carrier may not reach top speed before stopping at the next lift or induct point.

The carrier travels over the return lift back to the induct station level. The lift controllers, which may be separate controllers or the main sorter controller ensure only one carrier is on the lift at a time by signalling their status to the carriers so the carriers may have to stop and wait before entering the lifts. The carrier controller uses its sensors to detect any obstacles along the way and avoid collisions or to detect when the lift is not available. Alternatively, the lifts may allow more than one carrier if the position and direction of travel ensures that all carriers will be transported without being lowered or raised too far or otherwise obstructing the smooth operation of the lifts. Thus, a single sorting machine has a set number of circulating or moving carriers performing the sortation function over one or multiple levels of destination positions within a sorter framework on one floor of a building.

The sorter carriers may move between sorting machines by using further lifts or horizontal transfers. Sorting machines which include further lifts will now be discussed.

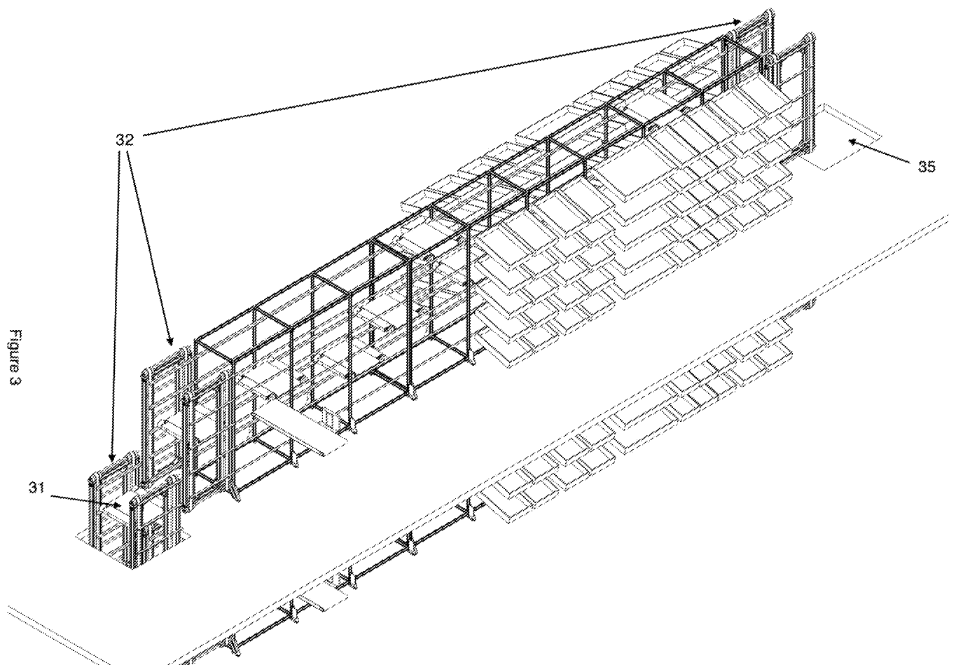

In FIG. 3, an example of two sorting machines separated by a building or mezzanine floor level is shown. The sorting machines are connected by the lift transporting carrier 31 through the mezzanine level. A second optional lift, not shown could be positioned to move the carriers between floors through another aperture in the floor shown at position 35. Alternatively, the lifts could be positioned at the ends or edges of the floors, or at any suitable position along the length of the sorting machine, at an appropriate location.

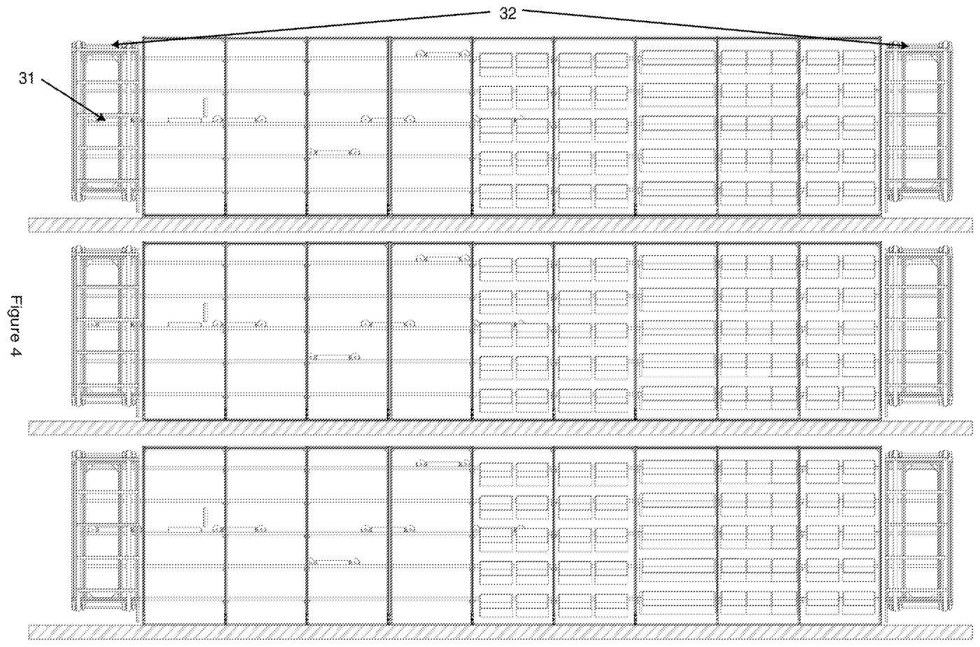

FIG. 4 shows three floors of a warehouse or storage facility, each having a sorting machine thereon. In the scenario shown in FIG. 4, each sorting machine is configured to operate independently, with sorter carriers moving within each sorting machine as described above.

Movement of items which may be required on a different floor of the warehouse or sorting facility would require movement between the sorting machines in another way; that is to say they would require the interaction of a further means of movement there between. In many cases, this would require the involvement of a person. When a group of items, to be brought together and collated into one of the destinations on a sorter, requires items from more than one floor of the warehouse, the items need to be moved in some way across floors.

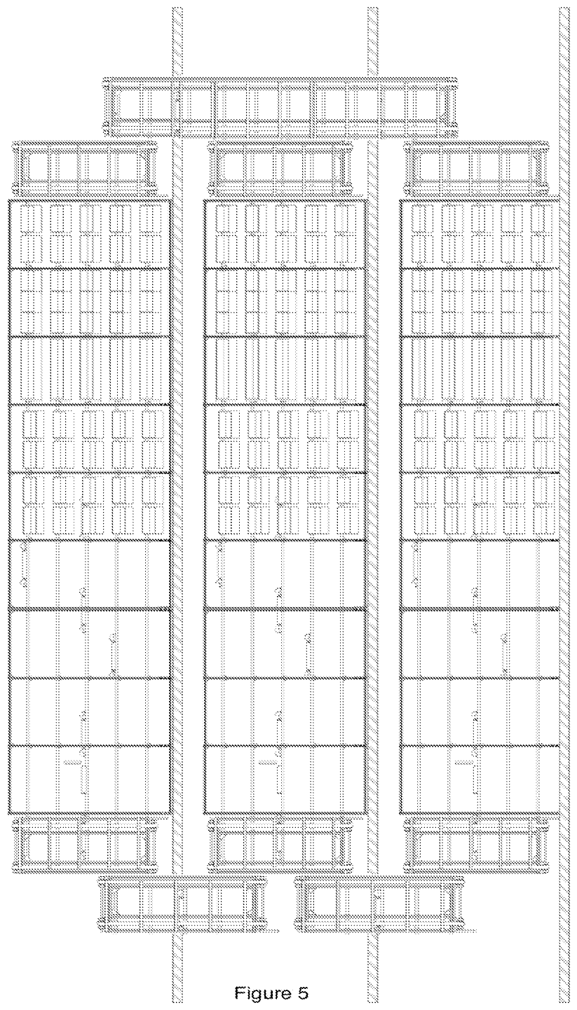

FIG. 5 shows a similar arrangement of sorting machines as that shown in FIG. 4, but with the addition of further lifts. Such lifts may connect the sorting machines together. In the scenario shown in FIG. 5, a first additional lift is positioned between the sorting machine on the ground floor and the sorting machine on the first floor, and a second additional lift positioned between the sorting machine on the first floor and the sorting machine on the second floor. A single lift spanning all floors is shown at the end of the machines away from the induct positions which can move a sorter carrier across two floors in one movement.

Packages which are inducted onto a carrier within the sorting system on the ground floor may be moved into the sorting system on the first floor by way of the first additional lift.

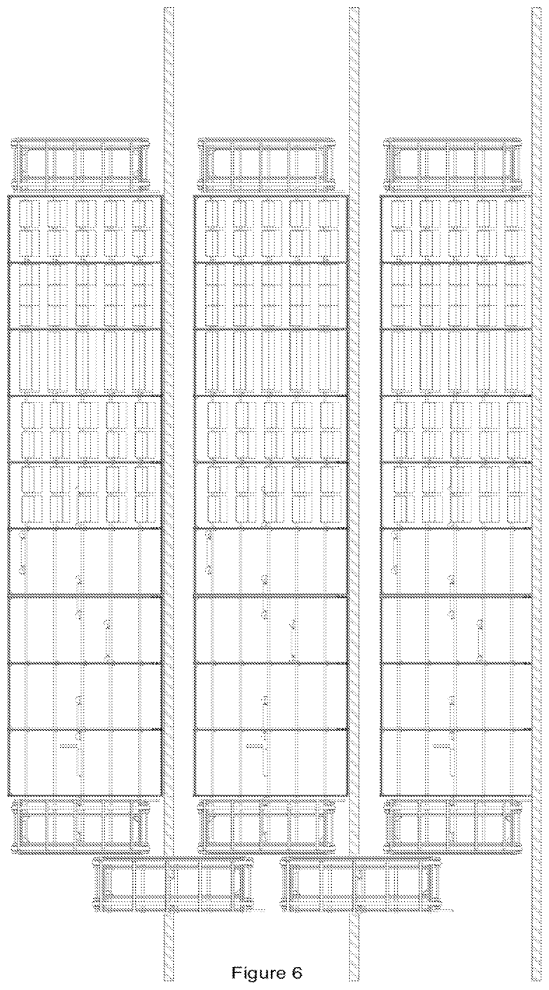

In FIG. 6, there are provided lifts at a first end of the sorting arrangement, and none at the second end. If only a very small percentage of items need to cross floors, then this lift may have sufficient capacity to move the carriers in both directions up and down. If, however, the percentage of items needing to cross floors becomes sufficiently high, additional lifts, usually at the other end of the sorter, can be used to provide the opposing up or down movement of carriers. Where a carrier moves across one floor, taking an item, an imbalance arises in the number of carriers, from the nominal number on each floor. The imbalance is corrected by any carrier, not necessarily the original carrier, returning to the original floor. This movement may advantageously include the transportation of an item required on the destination floor but may not.

In the arrangement shown in FIG. 6, the ‘staggered’ lift arrangement means that an item may be moved from the top floor onto the middle floor, and at the same time, using separate lifts, an item may be moved from the ground floor onto the middle floor. Such ‘staggered’ lifts allow for two concurrent floor transitions.

It is to be understood that in sorting systems and apparatuses as described herein, the lifts can either be dedicated to transporting carriers in one direction or be bidirectional. Advantageously travel paths within loops utilising lifts moving predominantly in the same direction facilitate high capacity and ease of control.

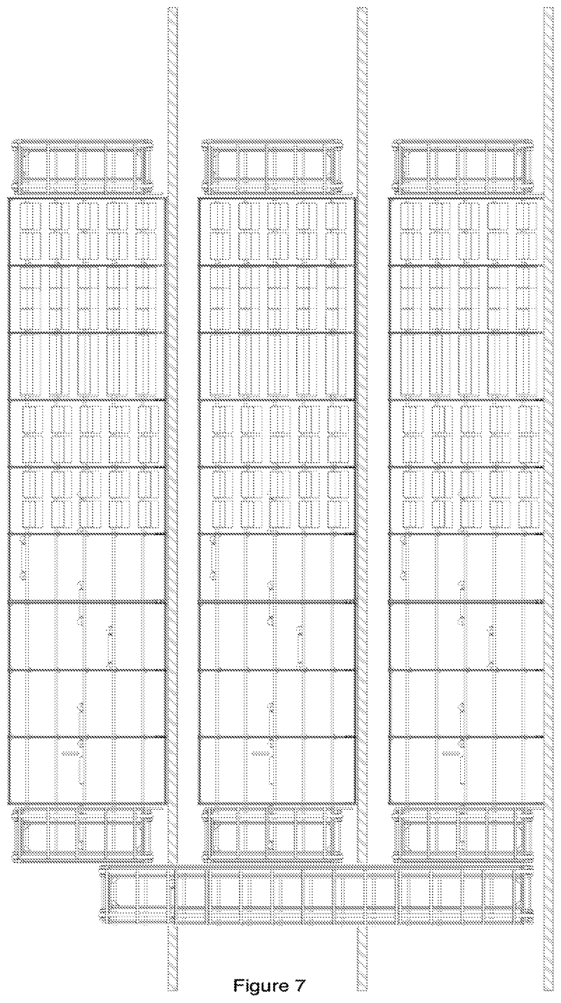

A single lift at the first end of the sorting arrangement, shown in FIG. 7, would mean that only one direction of floor transition could be made at a time. Alternatively the lift would need multiple independent lift platforms which had a way of preventing collision. Such multiple independent lift platforns in the same lift shaft can be described as different lifts.

There is therefore an advantage in having a decoupling between the lifts. One part of this is that a lift can be a standard part, such that it becomes an off-the-shelf component. The other is that sorter carriers may move around the system more easily, thus improving the efficiency of collating items. Additionally, any of the individual sorter system can run as a stand-alone machine without movement of carriers between floors.

The first additional lift may therefore enable the movement of packages between two floors of the warehouse or storage facility without the package requiring movement by a human or other method of movement.

In a similar way, the second additional lift may enable packages to be moved between the sorting system on the first floor and the sorting system on the second floor.

As a result an item inducted onto a sorter carrier on any floor can reach any destination on any of the floors. Items from all floors can be brought together into a single destination chute or order on any one of the floors.

The capacity of the system for cross floor movement (and therefore the effectiveness of the system to move packages between floors of the warehouse or storage facility) may be increased with the provision of further lifts either at the ends, in the middle, or somewhere along the length of the sorting frameworks/machines.

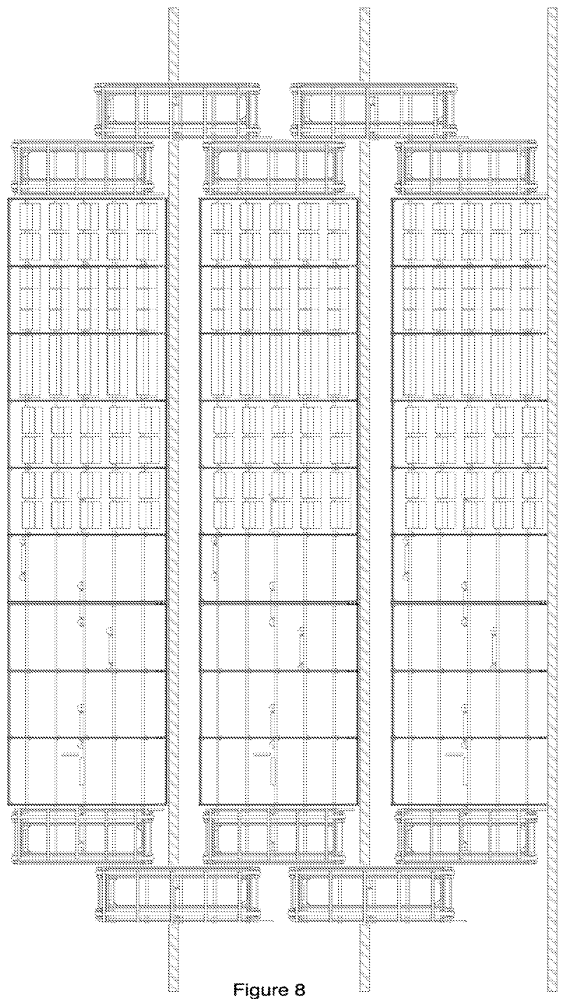

In FIG. 8, two further additional lifts are included in the system when compared to FIG. 6. These further lifts may provide a ‘return’ pathway for sorter carriers moving between sorting systems on different floors.

The effectiveness of the system for cross floor movement may be improved further with the provision of a single lift between floors, as shown in FIG. 7. In this scenario, a large lift is provided on the left-hand side of the sorting systems shown, such that a sorter carrier may move between any of the building levels or the individual levels of each sorting system. A return path could be provided by way of the two-lift arrangement discussed in connection with FIG. 8 or another single lift spanning all floors or another lift arrangement.

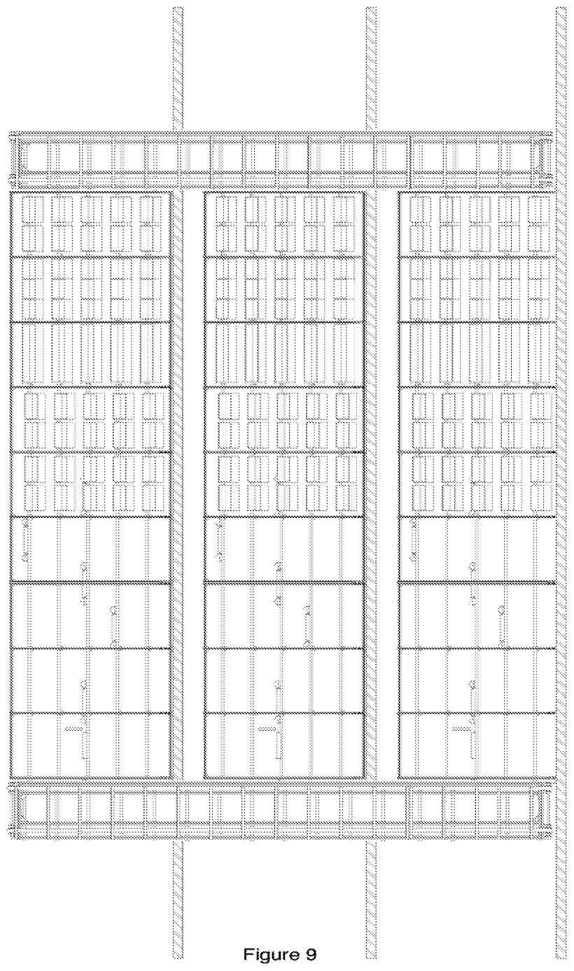

FIG. 9 shows an arrangement with only two large lifts, one at each side thereof, which in effect turns the three separate sorting systems into one large sorting system which spans three floors of a building. Items may be inducted into the system on any level, and may be routed to any sort destination among any of the three floors.

It may be the case that the arrangement shown in FIG. 9 has lower capacity than that of the arrangement shown in previous Figures. However, compared to FIG. 8, many lifts are removed, which may reduce the overall capacity of the system, but may also reduce the overall cost of the system.

Such an arrangement as described herein may provide a very versatile system that reduces the requirement for the movement of packages between floors of a warehouse or storage facility. Items to be packed may be inducted into the system on any floor, from any storage area, and routed to a sort destination within the system with any other items, from any other floor, ready to be packed or despatched.

Further floors may be included in the system, with a lift or lifts connecting the sorting systems on each floor.

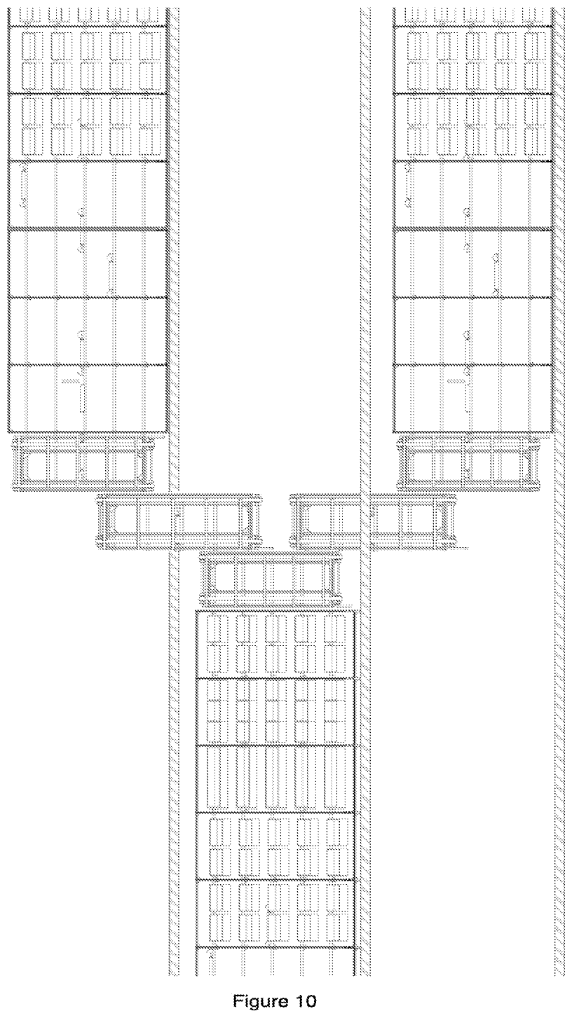

It is also envisaged that the sorting machines may be offset, such that a lift at a first end of one machine connects with the second end of another machine as shown in FIG. 10.

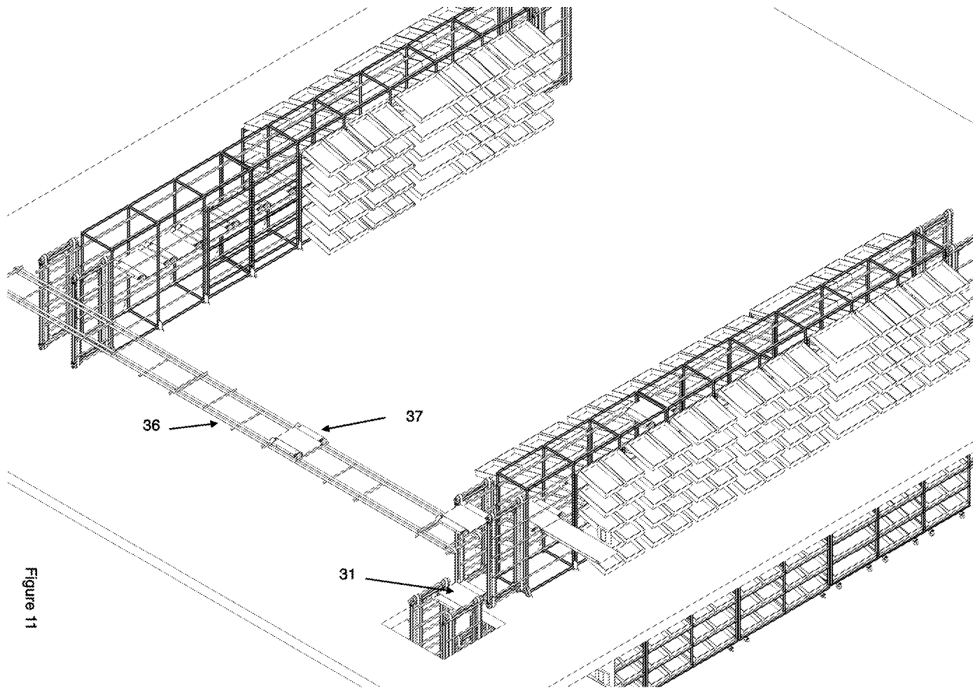

Sorting machines may also be connected on the same floor, to enable a sorter carrier to move between sorting machines as shown in FIG. 11. A sorter carrier may be within a first sorting machine, and the sorter carrier and therefore the item which has been inducted thereon may be required in a different sorting machine. FIG. 11 shows a carrier 31 transitioning through a floor level and another carrier 37 transitioning between sorters horizontally on the same floor over a transfer 36. The support and connecting mechanisms for the horizontal transfer are not shown.

These sorting machines may include a lift which reaches a further level, above the sort destinations shown in the Figures. This level may include a top rail, onto which the sorter carrier may drive, out of the lift.

This top rail may be used to enable the sorter carrier to drive to another sorting machine, drive into the lift thereof, or drive to or from a horizontal transfer position and become introduced into the system. However, such a top rail arrangement may necessitate the sorting machines either being aligned with each other, or the top rail arrangement being shaped to enable the sorter carrier to drive therealong.

An alternate configuration may include a loop of belt, onto which the sorter carrier may drive from the top rail. The loop of belt may have rails affixed thereupon which are a sorter carrier's width apart. This belt may be a level above sort destinations.

In an example, shown in FIG. 11 there is a sorting apparatus on a ground floor, and another sorter is provided on the floor above. A further sorter is also provided on the floor above, some metres away from the first sorter, in a sideways direction. Sorter carriers may be moved between the two horizontally-adjacent sorting machines on the first floor by way of the belt or transfer arrangement discussed above.

The system described herein may also be configured to balance the position and usage of the sorter carriers, by advantageously selecting the sequence of new orders to release and/or advantageously selecting the sort locations at which orders may be collated.

In an example, two items may be taken from the middle floor, one item from the top floor, and one item from the bottom floor, with the items collated at the middle floor. Such an arrangement may reduce the movement of carriers, because only two cross a floor.

This may, however, lead to an excess of sorter carriers on the middle floor. Therefore, it may be advantageous to collate the items on another floor. This may increase the number of floor transitions required, but may aid in balancing the sorter carriers across the floors. The control system may give consideration to all orders being processed within a time frame when considering how to best manage carrier movements.

A further aspect of the invention may implement an algorithm to determine the optimal sort location for a group of items. This may take into account the number of sorter carriers in the system, the sorting machines within which the sorter carriers are at a particular instance, the level of each sorting machine on which each sorter carrier is, the location at which items are being inducted into the system, and the time taken for each sorter carrier to arrive at a lift arrangement. In addition the other orders required on the system will influence the optimal sort location for any given order or group of orders to be placed. Where there is a choice between unallocated orders the sorter controller may choose to release and allocate an order to a sort location based upon items contained within the order and the carrier movements this would create leaving the other orders which could have been allocated until later.

The sorter control system may contain algorithms which take into account the positions of carriers in the system and the position of orders already allocated to sorting destinations when allocating new orders to sort destination positions within the warehouse to advantageously optimise the movement of carriers within the system and facilitate high capacity whilst minimising the total number of carriers required.

The use of an arrangement as described herein will now be discussed.

In a warehouse or storage facility setting, orders for items or Stock Keeping Units (SKUs) may be unpredictable. Items or SKUs may be categorised as being slow-moving, medium-moving, or fast-moving lines.

When planning the operation or capacity of a sorting system or plurality of sorting systems in a facility, it should be noted that customer order profiles and the rate at which orders are to be picked varies from day to day. Presently, items may be ordered on a first day, picked and packed the following day, and delivered on a third day. In some circumstances, however, items may be ordered, picked and packed, and delivered on the same day.

Books will be taken as the items in question in this example. At launch or new release, a book title will likely be a fast-moving item, but during the year after release, the book title may be a medium-or slow-moving title. This is, however, not always the case, with some book titles remaining fast-moving or medium-moving titles throughout their lifetimes. Some titles may be very fast-moving titles, then become slower moving and then regain popularity when the author releases another title.

In this example, the warehouse or sorting facility may include three floors, and in an optimal scenario, the stock items may be split such that a third of the items held and to be picked are on each floor. It may be difficult to achieve this in reality, so in the example of the books set out above, the fast-moving and very fast-moving titles may be split across the three floors, with a portion of the stock of each title on each floor. Medium-moving items may be placed on one or two floors, and slow-moving items placed on one floor only. The floors on which these medium-and slow-moving titles may be placed may, for example, be dictated by space requirements, or by the presence of other slow-or medium-moving titles on the other floors.

In the example above, when a collation of items, or an order, is to be picked, the position of the sorter carriers in the system may be taken as a snapshot, and along with the data about the order or collation of items, the location or locations from which the fast-and medium-moving titles are to be inducted into the system may be determined. Ideally the item is then picked from a location on the same floor as the induct position. Slow moving items, only available on one floor, would need to be picked and ideally inducted on that floor. The advantageous selection of which location to pick fast and medium moving titles from allows the balancing of workload on the floors and the balancing of carrier movements between floors. In addition, the number of carrier transitions between floors may be optimised.

The sorter control system may contain algorithms which take into account the positions of carriers in the system and the position of orders already allocated to sorting destinations and the location of SKU's when allocating new orders to sort destination positions within the warehouse to advantageously optimise the movement of carriers within the system and facilitate high capacity whilst minimising the total number of carriers required and balancing the workload of item picking.

The sort locations allocated to orders or collations of items may, in addition to the above, be balanced throughout the day. Packing operations are likely to be located near to where orders are collated and so balancing the use of the sort locations across floors over the working day may be desirable.

Ideally, a carrier moving upwards through the system with an item thereupon should be balanced by a carrier moving downwards through the system, also with an item thereupon.

However in certain circumstances it may be desirable to have a temporary imbalance of carriers between different floors or sorting machines. The system described is able to move sorter carriers between warehouse areas to help with temporary workload imbalances and then rebalance at a later time. This can help the warehouse operations deal with imbalances of wokload caused by imbalanced demand or poor stock putaway strategies. In this way the total number of carriers in the system can be reduced.

The sorter carriers as described herein are constrained to move within a system of rails. Prior art systems have proposed the use of autonomous guided vehicles, (‘AGVs’), which are directed and controlled by guide wires or similar arrangements within the floor of a warehouse or storage facility. Such systems do not confer the advantages described above.

A sorting system which moves independently driven sorting carriers within a framework spanning more than one warehouse floor or level to collect items which have been picked and in which the carriers can then move the item(s) within the sorting system framework to any position on any one of the warehouse floors where the items can be sorted into specific order containers containing one or more orders.

A control system, with stock placed advantageously, sequencing orders in such a way to maintain balance across floors, to give ease of control and higher capacity.

A sorting system comprising interlinked sorting system portions or machines, in which independently driven carriers can move between sorter portions or machines across a warehouse and across warehouse floors where the carrier or sorting machine control system maintains knowledge of the position of each carrier and can pass this information to another control system which can optimally balance the workload, (including by controlling the sequence new orders are released to be processed) order placement at sorter destinations and pick locations to advantageously balance workload throughout the working period for operators and equipment.

While the invention has been illustrated and described in detail in the drawings and preceding description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. Each feature of the disclosed embodiments may be replaced by alternative features serving the same, equivalent or similar purpose, unless stated otherwise. Therefore, unless stated otherwise, each feature disclosed is one example of a generic series of equivalent or similar features.

In the claims, the word “comprising” does not exclude other elements or steps, and the indefinite article “a” or “an” does not exclude a plurality. Any reference signs in the claims should not be construed as limiting the scope.

1. A sorting system which includes at least one independently-driven sorter carrier within a framework, wherein the sorting system spans at least two floors of a warehouse, and
the sorter carriers are configured to move within the framework and collect at least one item, and to move to at least one sort destination on any of the floors of the warehouse, such that items are sorted into at least one order, wherein the or each sorter carrier is further configured to offload the at least one item at the at least one sort designation.

2. (canceled)

3. The sorting system of claim 1, wherein the framework spans the at least three floors of the warehouse.

4. The sorting system of claim 3, further including a lift arrangement.

5. The sorting system of claim 4, wherein the lift arrangement is configured to pass through the floors or between the floors of the warehouse at an end of a floor and between a first portion of the framework and a second portion of the framework.

6. (canceled)

7. The sorting system of claim 4, wherein the lift arrangement is formed of two or more lifts, positioned anywhere along the framework.

8. (canceled)

9. (canceled)

10. The sorting system of claim 7, wherein the first and second lifts are each formed of two or more lifts.

11. The sorting system of claim 7, wherein the sorting arrangement spans at least three floors of the warehouse, and the framework is present on the at least three floors of the warehouse, further including lifts which pass between the first and second, and second and third floors respectively.

12. The sorting system of claim 1, further including an additional portion of framework on the same floor of the warehouse, wherein the additional portion of framework is connected to the existing framework by way of a horizontal transfer arrangement allowing sorter carriers to move between portions of the framework.

13. (canceled)

14. The sorting system of claim 11, wherein the horizontal transfer arrangement is an elevated above ground level such that a person may walk under the transfer and allow access to other areas of the warehouse.

15. (canceled)

16. (canceled)

17. (canceled)

18. (canceled)

19. The sorting system of claim 4, wherein the sorting system includes at least two sorter carriers.

20. The sorting system of claim 19, wherein the lift arrangement is configured such that when a first sorter carrier is moved in a first lift, a second sorter carrier is moved in a second lift.

21. (canceled)

22. The sorting system of claim 1, wherein the sorting system further includes a capacity management arrangement configured to optimise, reduce, or balance the movements of sorter carriers within the sorting system which spans multiple floors and areas of a warehouse to maintain a desired balance of the number of carriers on each floor and in each area facilitating high sorting capacity of the system.

23. The sorting system of claim 22, wherein the capacity management arrangement is configured further to optimally sequence orders to be processed and to allocate these orders or (groups of items to be collated) to available sort destinations within a framework of destinations in order to optimize, balance or reduce the sorter carrier movements between floors or areas and wherein the control system takes into account existing orders allocated to sort destinations, future orders to be allocated and the existing and expected positions of sorter carriers.

24. The sorting system of claim 23, wherein the capacity management is configured further to optimize, reduce, and/or balance the movement of sorter carriers between floors or areas of the sorter system by controlling the floor or area where an item is inducted into the system when the item is available in multiple stock locations within the warehouse.

25. The sorting system of claim 21, wherein the capacity management arrangement is configured to balance the movement of the or each sorter carrier within the system by moving another carrier into the sorting machine or system portion the first carrier left;
wherein the real-time demand is determined by one or more of the number of items in the sorting system, the floor on which items to be inducted in the system are positioned, or the floor, or position, of the relevant sort location; and/or
wherein the movement of the or each sorter carrier in the system is controlled such that the position of the or each sorter carrier is determined based upon the real-time demand on the sorting system.
